(19) United States
(12) Patent Application Publication
(10) Pub. No.: US 2025/0026573 A1
(43) Pub. Date: Jan. 23, 2025

(54) Methods And Systems For Moving Blanks And Constructs

(71) Applicant: Graphic Packaging International, LLC, Atlanta, GA (US)

(72) Inventors: Timothy W. Hendricks, Acworth, GA (US); Pete Karst, Canton, GA (US); Kevin T. May, Kennesaw, GA (US)

(21) Appl. No.: 18/776,589

(22) Filed: Jul. 18, 2024

Related U.S. Application Data
(60) Provisional application No. 63/527,652, filed on Jul. 19, 2023.

(51) Int. Cl. B65G 15/22; B65G 15/44

(52) U.S. Cl. CPC B65G 15/22; B65G 15/44

(57) ABSTRACT

A conveyor assembly for moving one or more products includes a conveyor belt configured to rotate along a first closed path, the conveyor belt having a body defining at least one lug receiving slot, and at least one lug belt at least partially supporting at least one lug thereon, the at least one lug belt configured to rotate along a second closed path such that the at least one lug is for being at least partially received in the at least one lug receiving slot.

### CROSS-REFERENCE TO RELATED APPLICATION

The present application claims the benefit of and priority to U.S. Provisional Patent Application No. 63/527,652, filed on Jul. 19, 2023.

### INCORPORATION BY REFERENCE

The disclosure of U.S. Provisional Patent Application No. 63/527,652, filed on Jul. 19, 2023, is hereby incorporated by reference for all purposes as if set forth in its entirety.

### BACKGROUND OF THE DISCLOSURE

The present disclosure generally relates to systems and methods of moving one or more blanks and/or constructs at least partially formed therefrom through a system.

### SUMMARY OF THE DISCLOSURE

According to one embodiment, the disclosure is generally directed to a conveyor assembly, the conveyor assembly comprising a conveyor belt configured to rotate along a closed path, the conveyor belt comprising a body defining at least one lug receiving slot.

According to one aspect, the disclosure is generally directed to a conveyor assembly for moving one or more products, the conveyor assembly comprises a conveyor belt configured to rotate along a first closed path, the conveyor belt comprising a body defining at least one lug receiving slot, and at least one lug belt at least partially supporting at least one lug thereon, the at least one lug belt configured to rotate along a second closed path such that the at least one lug is for being at least partially received in the at least one lug receiving slot.

According to another aspect, the disclosure is generally directed to a method of operating a conveyor assembly for moving one or more products, the method comprising obtaining a conveyor belt arranged along a first closed path, the conveyor belt comprising a body defining at least one lug receiving slot, obtaining at least one lug belt at least partially supporting at least one lug thereon and arranged about a second closed path, rotating the conveyor belt along the first closed path, and rotating the at least one lug belt along the second closed path such that the at least one lug is for being at least partially received in the at least one lug receiving slot.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a perspective view of a system including a conveyor assembly according to an exemplary embodiment of the present disclosure.

FIG. 2 is an enlarged view of a portion of the system of FIG. 1.

FIG. 3 is a perspective view of a portion of a conveyor belt of the conveyor assembly of FIG. 1 according to an exemplary embodiment of the present disclosure.

FIG. 4 is a perspective view of the system of FIG. 1 showing a group of products engaged by at least one lug.

Corresponding parts are designated by corresponding reference numbers throughout the drawings.

### DETAILED DESCRIPTION OF THE EXEMPLARY EMBODIMENTS

The present disclosure generally relates to a system and method including moving a blank or other construct for further processing and/or for forming trays, cartons, carriers, containers, and/or other constructs for holding products such as food or beverage products. In some embodiments, articles described herein can be product packages, wrappings, containers, bottles, cans, etc., that are at least partially disposed within the construct embodiments.

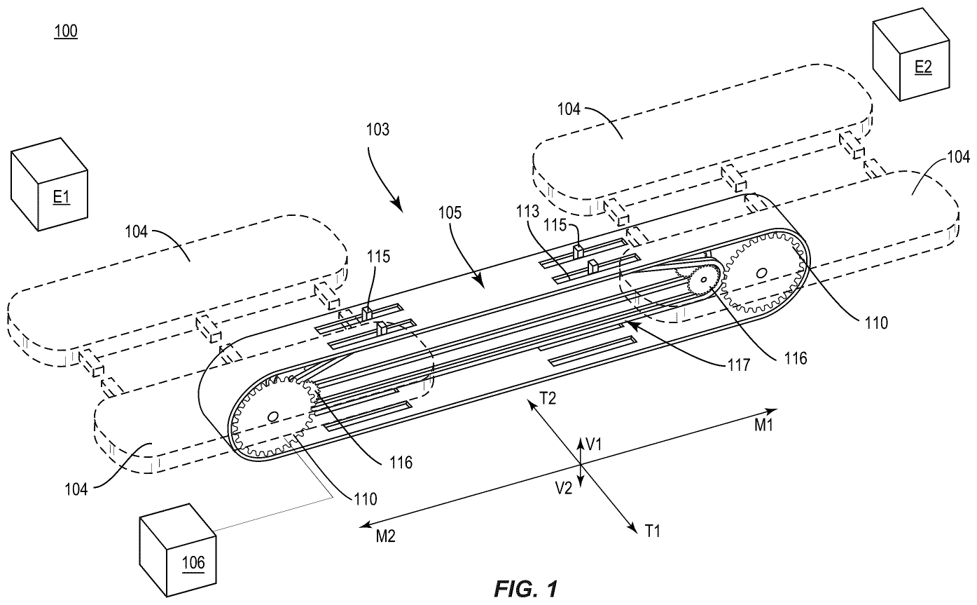

FIG. 1 is a perspective view of a portion of a system 100 that includes at least one conveyor assembly 103 as shown. As described herein, the at least one conveyor assembly 103 can be a portion of the system 100 for moving one or more blanks, constructs, or at least partially formed configurations thereof in a downstream machine direction M1 that at least partially extends away from an upstream end of the system 100 toward a downstream end of the system 100. An upstream machine direction M2 can be defined opposite the machine direction M1. Furthermore, first and second transverse directions T1, T2 can be defined extending perpendicularly away from the machine directions M1, M2 along a plane generally defined by the at least one conveyor assembly 103.

In this regard, the conveyor assembly 103 can be configured to move one or more blanks/constructs in the machine direction M1, for example, from an upstream station or component E1 of the system 100. In some embodiments, such stations or systems can include one or more of blank feeder assemblies, blank processing assemblies (such as folding assemblies, gluing assemblies), product loading assemblies, product grouping assemblies, product metering assemblies, turner and/or divider stations, etc. In some embodiments, an upstream end of the system 100 can be at least partially defined by the conveyor assembly 103.

Furthermore, the conveyor assembly 103 can be configured to move the one or more blanks/constructs in the machine direction M1 toward a downstream station or component E2 of the system 100, for example, one or more of blank processing assemblies (such as folding assemblies, gluing assemblies), product loading assemblies, product grouping assemblies, product metering assemblies, construct and/or product wrapping stations, turner and/or divider stations, etc. In some embodiments, a downstream end of the system 100 can be at least partially defined by the conveyor assembly 103.

As shown, the conveyor assembly 103 can include one or more supports 104, e.g., guides, rails, plates, rods, etc., for at least partially maintaining movement of one or more items supported on the conveyor assembly 103 along the machine direction M1.

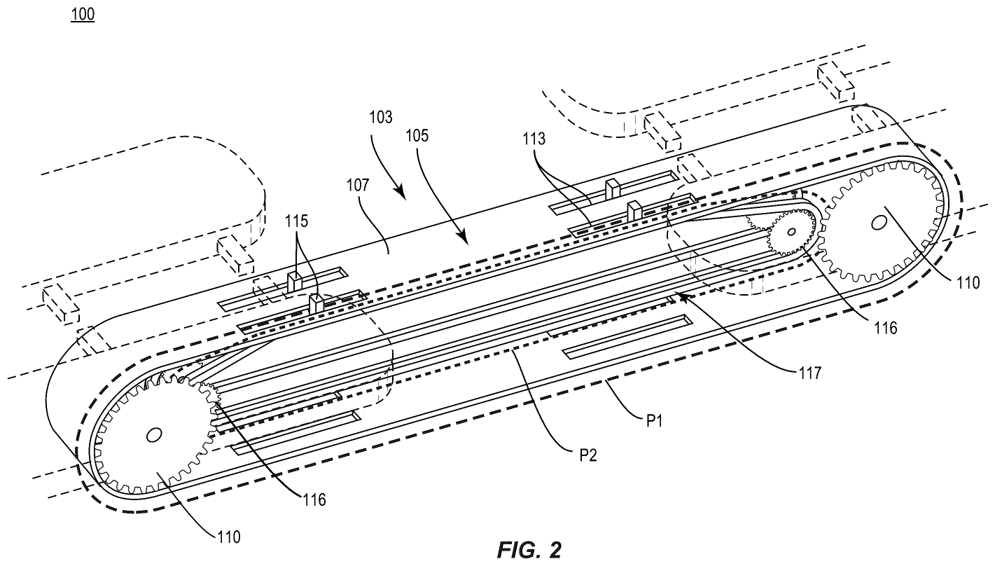

With additional reference to FIG. 2, in the illustrated embodiment, the conveyor assembly 103 can include a conveyor belt 105 extending in an at least partially closed path P1 (broadly, “first closed path”). In some embodiments, the conveyor belt 105 can be arranged in a generally elliptical path, though it will be understood that one or more portions of the closed path P1 include one or more of generally oblique, straight, and curved portions extending away from a generally elliptical path.

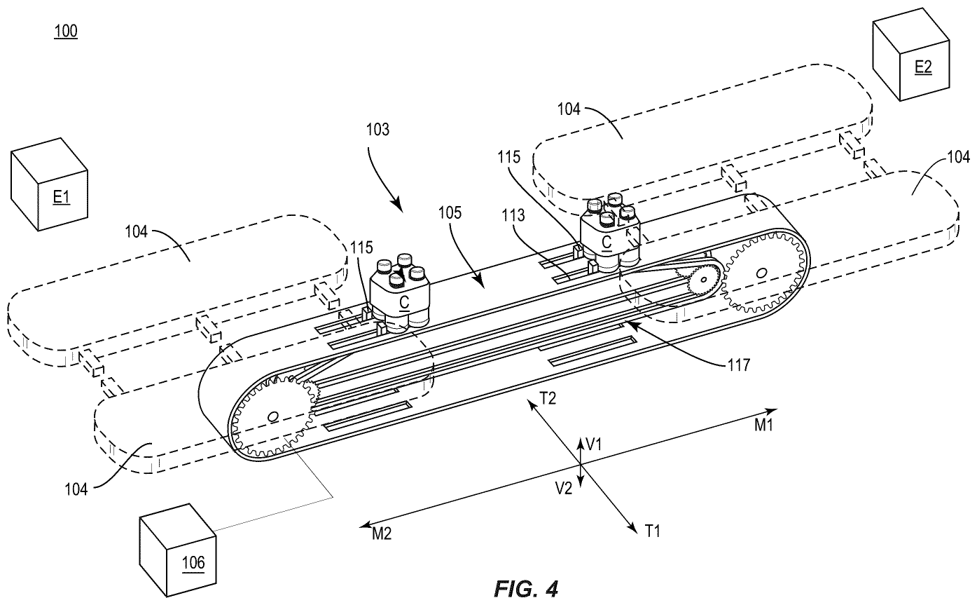

An upper surface of the conveyor belt 105 can thus generally move one or more products C (FIG. 4) supported thereon in the machine direction M1, a surface portion of the conveyor belt 105 can generally move in the machine direction M2, an upstream portion of the conveyor belt 105 can generally move in a vertical direction V1 transverse to each of the directions M1, M2, T1, T2, and a downstream portion of the conveyor belt 105 can generally move in a vertical direction V2 opposite the vertical direction V1.

In this regard, one or more portions of the conveyor belt 105 can be arranged extending around or otherwise in mechanical communication with a respective driving mechanism, e.g., rotational components such as sprockets 110, rollers, pulleys, gears, belts, etc. of the system 100. In one embodiment, such rotational components can be directly rotated by a driving member/rotational actuator 106, e.g., one or more motors or other prime mover(s). While the actuator 106 is illustrated schematically in FIG. 1, it will be understood that one or more intermediate mechanical transmissions can be provided between such actuator(s) and one or more rotational members about which the conveyor belt 105 is disposed.

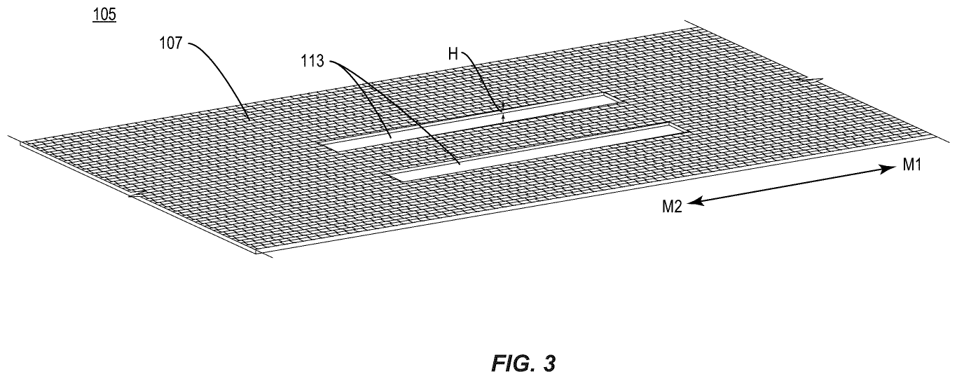

With reference to FIGS. 1-3, the conveyor belt 105 can have a body 107 that is generally arranged in annular form, and having a width W at least partially defined along the directions T1, T2 between a first lateral edge 109 of the body 107 and a second lateral edge 111 of the body 107, and a thickness H at least partially defined along the directions V1, V2.

As shown, the body 107 of the conveyor belt 105 can at least partially define a plurality of lug receiving slots 113 (broadly, “first lug receiving slot” and “second lug receiving slot”) each spaced apart from the respective free edges 109, 111 of the conveyor belt 105. Each lug receiving slot 113 can extend through the thickness H of the body 107 of the conveyor belt 105 and at least partially along the directions M1, M2 so as to have an elongate configuration, thought it will be understood that the slots 113 can have a different configuration without departing from the disclosure.

In some embodiments, the body 107 of the conveyor belt 105 can be provided and one or more portions thereof can be mechanically removed, e.g., cut away, to form the respective slots 113. For example, in some embodiments, the body 107 of the conveyor belt 105 can be subject to cutting by a solid cutting tool, a waterjet, a laser, etc. to define the slots 113 therein. In some embodiments, the body 107 of the conveyor belt 105 can be formed from a plurality of interconnected components, e.g., links, chains, etc., that are arranged with one or more discontinuities corresponding to the respective slots 113.

It will be understood that the body 107 of the conveyor belt 105 can be formed from one or more of polymeric, composite, and/or metallic materials, including combinations thereof.

As described herein, the slots 113 in the body 107 of the conveyor belt 105 can be configured to at least partially receive one or more respective lugs 115 (broadly, “first lug” and “second lug”) for engaging a respective product C supported on the conveyor belt 105. In some embodiments, such lugs 115 can be carried on one or more lug belts 117 (broadly, “first lug belt” and “second lug belt”) or other bodies driven to rotate along a substantially closed path P2 (broadly, “second closed path”), e.g., one or more, loops, chains, etc., with the lugs 115 arranged in generally upstanding relation with such bodies. In some embodiments, the first lug belt 117 can be driven to rotate along the substantially closed path P2 and the second lug belt 117 can be driven to rotate along a third substantially closed path that is generally similar and spaced apart from the path P2.

The bodies that carry the lugs 115 can be driven to rotate, for example, with a respective driving mechanism, e.g., rotational components such as sprockets 116, rollers, pulleys, gears, belts, etc. of the system 100. In one embodiment, such rotational components can be directly rotated by a driving member/rotational actuator, e.g., one or more motors, or one or more intermediate mechanical transmissions can be provided between such motor(s) and the rotational actuator(s). In some embodiments, the belt(s) 117 can be driven to rotate via a mechanical actuator common to that configured to rotate the conveyor belt 105, e.g., the actuator 106. In other embodiments, more than one actuator 106 can be provided to drive multiple respective sprockets 110, 116.

As shown, the path P2 along which the lugs 115 are carried along a respective body at least partially intersects and/or traverses the path P1 such that respective lugs 115 can be carried to at least partially extend through the slots 113. In this regard, depending upon the path P2 of the belt(s) 117, one or more of the lugs 115 can be driven to insert at least partially through a respective slot 113, and, optionally, thereafter, withdraw downwardly from the respective slots 113 away from the path P1.

Accordingly, a portion of the path P2 can be arranged in an intersecting orientation relative to a respective portion of the path P1, for example, so that respective lugs 115 carried in a vertically upstanding arrangement on the respective lug belts 117 can be driven to be at least partially received or withdrawn in the respective slots 113 in the conveyor belt 105.

Furthermore, a portion of the path P2 can be arranged tangential relative to a respective portion of the path P1, for example, so that the lugs 115 can be carried on the respective lug belts 117 in a generally parallel arrangement with the conveyor belt 105.

In this regard, and as shown in FIG. 4, the slots 113 are configured and dimensioned to at least partially receive the lugs 115 such that the lugs 115 can be driven in at least partially synchronous timing with the conveyor belt 105, for example, as determined by a controller operably connected one or more actuators, e.g., the actuator 106, or a transmission element. In such an arrangement, the lugs 115 can be positioned to engage a product C, for example, a blank, carrier, package, grouping of bottles and/or cans, other constructs, etc. Such engagement can be to maintain a relative position of the product C on the conveyor belt 105, to adjust such position, to adjust a speed of the product C on the conveyor belt 105, to further group products or portions thereof together, etc.

In some embodiments, the lugs 115 are afforded a clearance by the length of the slots 113 in the directions M1, M2 that allows the lugs 115 to travel therealong relative to the conveyor belt 105, e.g., such that the lugs 115 can be driven to accelerate or decelerate relative to the conveyor belt 105, or can otherwise be driven at a different speed than the conveyor belt 105. As described herein, such speed can generally refer to linear speeds along the directions M1, M2, e.g., in coplanar and/or parallel planar relation with an upper surface of the body 107 of the conveyor belt 105, but, in some embodiments, can include speeds at least partially defined in another direction. In some embodiments, the amount of clearance or travel provided by a respective lug 115 in the respective directions M1, M2 can include the length of a respective slot 113 in the directions M1, M2.

In this regard, in some embodiments, one or more of the lugs 115 can be driven at a speed greater than that of the conveyor belt 105 so as to cause movement of the respective lug 115 along the respective slot 113 to engage a blank/article/product disposed thereon, for example, to cause such blank/article/product to move, e.g., such as by sliding, along a surface of the conveyor belt 105.

Such relative movement of a blank/article/product along a surface of the conveyor belt 105 can be effected, for example, for grouping purposes, to bring such item up to speed for a downstream operation of the system 100, etc. It will be understood that similar mechanics can be used to decelerate or brake a blank/article/product along a surface of the conveyor belt 105, e.g., by engaging a leading edge of such item with a respective lug 115 moving at a speed lower than that of the conveyor belt 105.

Products C supported on the conveyor belt 105 can thus be driven to slidably move therealong by one or more of the lugs 115 driven along the path P2. Such arrangement of the lugs 115 moving along the path P2 and the blanks/articles/products moving along the path P1, such paths P1, P2 at least partially intersecting one another, afforded by the slots 113 defined in the body 107 of the conveyor belt 105 can provide a compacted configuration that allows for precise and smooth control of objects along the conveyor belt 105. Such configuration and control can be advantageous as compared to, for example, arrangements in which a path along which lugs are driven is laterally spaced apart from the path P1 along the directions T1 and/or T2.

It will be understood that one or more components of the system 100 can have a different configuration, position, arrangement, etc., without departing from the disclosure.

It will also be understood that one or more of the components of the systems described herein can have a different configuration without departing from the disclosure. It will be further understood that suitable supporting structures (e.g., bases, legs, platforms, supports, braces, etc.) can be provided to support and facilitate operation of the various components described herein.

In general, the blanks of the present disclosure may be constructed from paperboard having a caliper so that it is heavier and more rigid than ordinary paper. The blank can also be constructed of other materials, such as cardboard, or any other material having properties suitable for enabling the construct to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A conveyor assembly for moving one or more products, the conveyor assembly comprising:
a conveyor belt configured to rotate along a first closed path, the conveyor belt comprising a body defining at least one lug receiving slot; and
at least one lug belt at least partially supporting at least one lug thereon, the at least one lug belt configured to rotate along a second closed path such that the at least one lug is for being at least partially received in the at least one lug receiving slot.

2. The conveyor assembly of claim 1, wherein the at least one lug receiving slot is spaced away from a free outer edge of the body of the conveyor belt.

3. The conveyor assembly of claim 2, wherein an upper surface of the body of the conveyor belt is configured to move in a first machine direction, a lower surface of the body of the conveyor belt is configured to move in a second machine direction, and the body of the conveyor belt has a thickness along a vertical direction transverse to the first machine direction and the second machine direction, the at least one lug receiving slot at least partially defined through the thickness of the body of the conveyor belt.

4. The conveyor assembly of claim 3, wherein the at least one lug extends upwardly along the vertical direction along a portion of the second closed path.

5. The conveyor assembly of claim 4, wherein the at least one lug receiving slot extends fully through the thickness of the body of the conveyor belt.

6. The conveyor assembly of claim 5, wherein a portion of the second closed path is tangential to a respective portion of the first closed path.

7. The conveyor assembly of claim 6, wherein a portion of the second closed path is arranged for intersecting a respective portion of the first closed path.

8. The conveyor assembly of claim 7, wherein each of the conveyor belt and the at least one lug belt are rotatably driven by a respective at least one sprocket.

9. The conveyor assembly of claim 8, wherein the at least one lug receiving slot is a first lug receiving slot at least partially defined through the thickness of the body of the conveyor belt, and a second lug receiving slot is at least partially defined through the thickness of the body of the conveyor belt, the second lug receiving slot is spaced apart from the first lug receiving slot along a direction transverse to each of the first machine direction, the second machine direction, and the vertical direction.

10. The conveyor assembly of claim 9, wherein the at least one lug is a first lug, the at least one lug belt is a first lug belt, and the conveyor assembly further comprises a second lug belt supporting a second lug moving along a third closed path generally parallel to the second closed path such that the second lug is for being at least partially received in the second lug receiving slot.

11. A method of operating a conveyor assembly for moving one or more products, the method comprising:
obtaining a conveyor belt arranged along a first closed path, the conveyor belt comprising a body defining at least one lug receiving slot;
obtaining at least one lug belt at least partially supporting at least one lug thereon and arranged about a second closed path;
rotating the conveyor belt along the first closed path; and
rotating the at least one lug belt along the second closed path such that the at least one lug is for being at least partially received in the at least one lug receiving slot.

12. The method of claim 11, wherein the at least one lug receiving slot is spaced away from a free outer edge of the body of the conveyor belt.

13. The method of claim 12, wherein the conveyor belt is rotated such that an upper surface of the body of the conveyor belt moves in a first machine direction, a lower surface of the body of the conveyor belt moves in a second machine direction, the body of the conveyor belt has a thickness along a vertical direction transverse to the first machine direction and the second machine direction, and the at least one lug receiving slot is at least partially defined through the thickness of the body of the conveyor belt.

14. The method of claim 13, wherein the at least one lug belt is rotated such that the at least one lug extends upwardly along the vertical direction along a portion of the second closed path.

15. The method of claim 14, wherein the at least one lug receiving slot extends fully through the thickness of the body of the conveyor belt.

16. The method of claim 15, wherein the at least one lug belt is rotated such that a portion of the second closed path is tangential to a respective portion of the first closed path.

17. The method of claim 16, wherein the at least of lug belt is rotated such that a portion of the second closed path is arranged for intersecting a respective portion of the first closed path.

18. The method of claim 17, wherein rotating each of the conveyor belt and the at least one lug belt comprises rotatably driving the respective conveyor belt and the at least one lug belt with a respective at least one sprocket.

19. The method of claim 18, wherein the at least one lug receiving slot is a first lug receiving slot at least partially defined through the thickness of the body of the conveyor belt, and a second lug receiving slot is at least partially defined through the thickness of the body of the conveyor belt, the second lug receiving slot is spaced apart from the first lug receiving slot along a direction transverse to each of the first machine direction, the second machine direction, and the vertical direction.

20. The method of claim 19, wherein the at least one lug is a first lug, the at least one lug belt is a first lug belt, and the conveyor assembly further comprises a second lug belt supporting a second lug, and the method further comprises rotating the second lug belt along a third closed path generally parallel to the second closed path such that the second lug is for being at least partially received in the second lug receiving slot.
